(19) United States
(12) Patent Application Publication
(10) Pub. No.: US 2022/0148046 A1
(43) Pub. Date: May 12, 2022

(54) METHOD FOR MONITORING A SUM, ASSOCIATED SYSTEM

(71) Applicant: Théo Michaël DAOUDI, PARIS (FR)

(72) Inventor: Théo Michaël DAOUDI, PARIS (FR)

(21) Appl. No.: 17/430,479

(22) PCT Filed: Mar. 10, 2020
(86) PCT No.: PCT/EP2020/056380

§ 371 Date: Aug. 12, 2021

(30) Foreign Application Priority Data
Mar. 11, 2019 (FR) 1902463

(51) Int. Cl. G06Q 30/02; G06Q 20/10; G06Q 40/00

(52) U.S. Cl. CPC G06Q 30/0279; G06Q 50/01; G06Q 40/12; G06Q 20/10

(57) ABSTRACT

A method for tracking a sum between a first donor and a receiving entity includes defining a project including a selection of a first sum and a receiving entity from a user interface of a user terminal; transferring the first sum from a first account of the first donor to a second account of the receiving entity; generating a digital fingerprint associating an identifier of the first donor and one identifier of the project; generating a first notification including a first processing indicator, called an allocation indicator, indicating an association of the project identifier with a second geographical zone, a second date and an amount of a second sum less than or equal to the first sum; generating a second notification including a second processing indicator, called a distribution indicator, indicating an association of the project identifier with a third geographical zone, a third date and a state.

### FIELD

The field of the invention relates to methods and systems for generating notifications in order to track the state of a transaction and its usage based on physical parameters and state indicators. In particular, the field of the invention relates to methods including steps for generating a set of notifications to a donor and defining an interactive tracking of transferred donations.

### STATE OF THE ART

Solutions exist for tracking donations to organizations. As an example, patent document WO2008134448 discloses a method for knowing tracking information from a donation management system having on the one hand a first user interface for collecting donations from a community of donors and on the other hand a second interface for associating donations with different distribution channels provided by different organizations. The tracking information is therefore simply organizational for the user without providing any real information on the usage of donations.

Patent document WO2016196786 discloses a method for collecting digital data relating to tracking of a transaction from a donor to an organization. The disclosed method allows for the generation and transfer of digital evidence from transfer transactions between different organizations likely to manage the collected donations. The described method solves a problem related to the use of donations by local organizations that may not match a donor's charter. The disclosure appears to describe a solution to reduce corruption. However, this solution is silent on notification regarding the end use of donations and where they are allocated.

US20170132673 writes a method for tracking activities related to managing donations, especially to effectively promote and organize activities of humanitarian organizations. However, this document does not describe a solution for a donor to actually know the use of donations that are administered by organizations.

Therefore, there is a need to notify a donor of data related to the tracking of a donation.

### SUMMARY OF THE INVENTION

The invention hereinafter detailed overcomes the aforesaid drawbacks.

According to one aspect, the invention relates to a method for tracking a sum between a user, called a first donor and a receiving entity comprising the following steps of:
defining a project including a selection of a first sum and a receiving entity from a user interface of a user terminal;
transferring said first sum from a first account associated with the first donor to a second account associated with the receiving entity;
generating a digital fingerprint associating at least one identifier of the first donor and one identifier of the project;
generating a first notification including a first processing indicator, called an “allocation indicator”, indicating an association of the project identifier with a second geographical zone, a second date and an amount of a second sum less than or equal to the first sum;
generating a second notification including a second processing indicator, called a “distribution indicator”, said distribution indicator indicating an association of the project identifier with a third geographical zone, a third date and a state.

One advantage is to allow to deliver a real procedure of tracking a sum especially by indicating geographical locations at different stages of its processing. One advantage is to have a geographical criterion, the position or a geographical zone to generate a tangible indicator of processing the sum. The geographical position is an indicator that is a physical parameter not dependent on a criterion related to the organization of an entity or on internal or subjective criteria.

According to one aspect the invention relates to a method for automatically generating notifications for tracking a sum between a user, called a first donor and a receiving entity comprising the following steps of:
defining a project including a selection of a first sum and a receiving entity from a user interface of a user terminal;
transferring said first sum from a first account associated with the first donor to a second account associated with the receiving entity;
generating a digital fingerprint associating at least one identifier of the first donor with an identifier of the project;
automatically generating by a calculator to the first donor a first notification including a first processing indicator, called an “allocation indicator”, indicating an association of the project identifier with a second geographical zone, a second date and an amount of a second sum less than or equal to the first sum;
automatically generating by a calculator to the first donor a second notification including a second processing indicator, called “distribution indicator”, said distribution indicator indicating an association of the project identifier with a third geographical zone, a third date and a state.

According to one embodiment, defining a project includes selecting a first geographical zone. One advantage is that a user-defined zone can be taken into account to assign sums accordingly. The level of assignment of a zone may take into account a type of zone or the size of the zone.

According to one embodiment, a set of programs is predefined, each program defining a set of actions to be performed in a predefined zone on at least one given date. One advantage is to provide information for the user to identify predefined zones and associate sums therewith.

According to one embodiment, each program includes a first type allowing program categories to be defined. One advantage is to deliver information qualifying a program for a user.

According to one embodiment, defining a project includes selecting a first type. One advantage is to match user desires for a sum assignment with pre-existing categories of programs.

According to one embodiment, defining a project includes defining:
an impact indicator calculated on the proportion of a user's donation relative to a reference,
an urgency indicator calculated from the date of an event in a program,
an achievement indicator defined from a predefined value of an attribute of the event mentioning the result of an action.

One advantage is to return indicators to a user in order to inform him not only about tracking of the sums paid but also about the way the sums are used or allocated.

According to one embodiment, the first notification is issued following a modification of a piece of data characterizing the project within a database of a remote server gathering a set of projects, said piece of data being a digital status of the project or a piece of data relating to a new association of a project with a geographical zone or even to a piece of data relating to gathering of user projects in the same set of projects

According to one embodiment, the second notification is issued following the initiation of a transfer of a sum from the second account to a third account of an entity, the third account being attached to a geographical reference zone.

According to one embodiment, the method comprises a step of generating a third notification including a third processing indicator, called media indicator, said media indicator being associated with a media including at least one image. One advantage is to allow a media to be associated to represent an achievement of sums assigned to a program. The media can be issued to a community of users who have all contributed to the achievement of an action of a program.

Advantageously, this third notification is issued automatically following the association of a media with a project or a program to which a plurality of projects are attached.

According to one embodiment, the generation of a fourth notification including a second allocation indicator, said second allocation indicator indicating an association of the project identifier with a fourth geographical zone, a second date and an amount of a third sum less than or equal to the first sum. One advantage is to multiply the allocations or assignments of sums to different types of programs especially according to the amounts of the sums, the nature and the structure of the programs, etc. As the tracking of the sums is more complex, the method of the invention allows these different assignments to be automatically managed.

According to one embodiment, the first sum is divided into a plurality of sums according to conditions among which:
the amount S₁ is greater than a sum threshold MM_{AX};
a number of users Uᵢ is greater than a given threshold of users, said users having made a donation allocated to a same program;
a number of sub-programs of the same program including different dates,
an indicator of a user wishing to distribute his/her donation amount among different programs.

One advantage is to generate automatic rules allowing the management of a large number of users while maintaining proper tracking of the sums donated.

According to another aspect, the invention relates to a system including at least one user terminal, a terminal of an operator of an entity, communication means of said terminals, at least one server for generating notifications following at least one action performed by said operator on the second terminal, a second server for enabling a banking transaction from a first account to a second account, said terminals and the first server being configured to implement the method of the invention.

One advantage is to deploy management tools in different organizations while providing access capabilities to an offer from the internet for example fora plurality of users.

According to one aspect, the invention relates to a system including at least one user terminal, a terminal of an operator of an entity, communication means for connecting said terminals to a data network, at least one first server for generating notifications following at least one action performed by said operator on the second terminal, a second server for enabling a banking transaction from a first user account to a second account of an entity, the first terminal including a user interface for defining a project including an identifier, a first geographical zone and at least one sum, said data being transferred through a data network to at least the first remote server, the user interface further enabling said banking transaction to transfer said sum, the second terminal including a communication interface for retrieving the data transmitted by the first terminal and a user interface for associating a second geographical zone with said project, said data being stored within a memory of the first server to be then automatically transmitted via a first notification through the data network to the first terminal said first notification including at least one piece of data relating to the project and a data describing the second geographical zone and a date piece of data, a second notification being automatically sent to the first terminal successively to processing of part of the sum of the second bank account, said third notification including a piece of data characterizing a third geographical zone.

According to one embodiment, processing all or part of the sum may correspond to transferring the sum such as a bank transfer or a debit of the sum to a third bank account. The events for automatically generating the notifications can correspond to a modification in the database of the projects or programs, to a modification of a piece of data characterizing the project, an association between a project and a program or any other event resulting in a modification of a piece of data characterizing the project defined by the user.

Further characteristics and advantages of the invention will become apparent from the following detailed description, with reference to the appended figures, which illustrate:

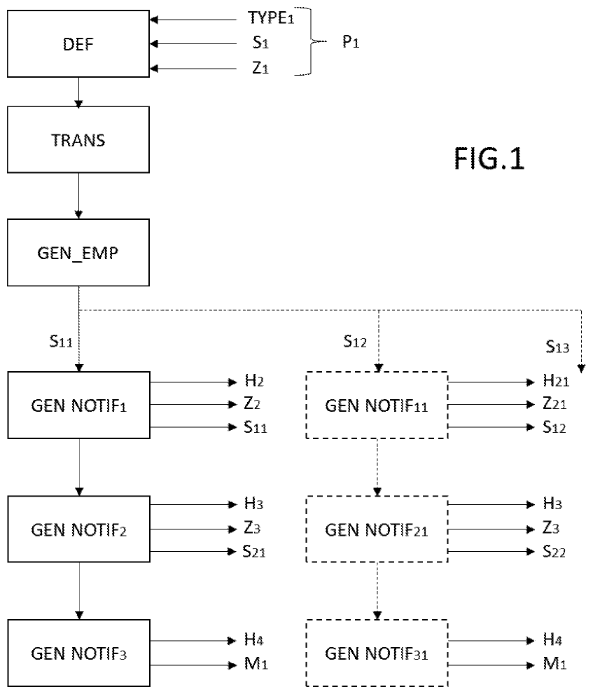

FIG. 1: an example of a sequence of steps according to one embodiment of the method of the invention describing some information exchanges between a donor and a donation management organization according to the method of the invention;

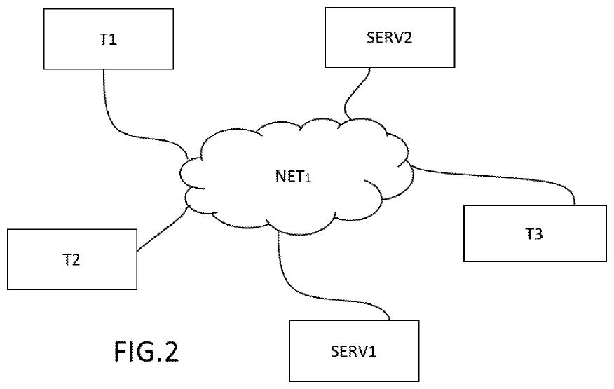

FIG. 2: an exemplary embodiment of a communication system of the invention enabling the implementation of the method of the invention.

In the present description, a program corresponds to a set of programmed actions of an entity in a given period of time and in a given location. The entity may be a legal entity or a natural person, for example: an international organization, an association, a foundation, a company, etc.

According to one example, it is possible to associate a plurality of entities to a given program. In the latter case, the first entity associated with this program includes a first status. The entities attached thereafter comprise a second status. The first and the second status may be used according to the method of the invention to assign or distribute write and/or read access rights to digital or electronic devices accessible to the entities. Among the rights are, for example, the right to issue notifications to users, the right to access the project database, the right to access the bank account receiving the users' sums.

A program can also include all the tasks related to the organization of actions. For example, a program could be the supply of water to a neighborhood in Timbuktu. This program then includes a start date and an initial period of 3 years. According to other examples, a plurality of periods can be defined. The different periods may correspond to different stages of a program or sub-program. The different periods may be of different lengths.

The program includes a set of actions such as a site operation, three local sanitation installations, a drilling operation and pump installation, a well to tank connection, etc. Typically, a program includes a budget estimate. In its simplest definition, a program can correspond to an event or a geographical zone, for example “Tsunami 2004” or “Water supply in Mali”.

FIG. 1 describes an exemplary embodiment of the method of the invention. The method includes a first step of defining DEF a new donation project.

A user U₁ accesses a platform via a digital interface, for example a smartphone or a tablet or a PC.

The platform is accessible from a user interface. It can be for example a WEB page accessible from a URL, said page being hosted on a server SERV₁.

According to one embodiment, this platform allows the administration of programs, users who are for example donors and tracking of their donations. In particular, it allows a user U₁ to access a set of program s and to associate a project P₁ with them. This platform allows to associate sums {Sᵢ}_{iε[1;N]} transmitted by users {Uᵢ}_{iε[1;N]}, with projects {Pᵢ}_{iε[1;N]}. A project P₁ includes a name to allow a user U₁ to designate and identify his/her project. A project P₁ is preferentially identified by an identifier. The latter can be automatically generated at its creation by a calculator and stored in a database of a memory. According to one example, the platform allows access to a set of programs to a user U₁. The platform includes an interface for selecting one or more programs and browsing the various information describing the program, its budget, its period, the relevant geographical zone, etc. According to one embodiment, the name of the program can be assigned to the newly defined project name. This assignment can be automatically suggested. Thus, fora U₁ user, it is more convenient to identify what his/her projects refer to when different projects are managed from the platform. This can be the case for a foundation with a large number of donations to different entities. In the latter case, the user U₁ is a legal entity.

According to one embodiment, the system of the invention includes a database including the project data of a plurality of users. This database comprises a structure allowing projects to be associated with user identifiers and programs associated with geographical zones as well as organizations or entities.

The data characterizing projects, programs, organizations or entities and users are therefore specially formatted to be stored in a physical memory when such a database is used. The memory is, for example, a database whose architecture allows an exploitation of the data characterizing these projects, geographical zones, organizations or entities, programs and identifiers. This architecture allows especially data to be extracted automatically in order to generate notifications automatically under certain conditions. Thus, data such as user identifier, sum value, currency, project identifier, project name, project type, program name, program identifier, program type, TAG, organization or entity name, organization or entity identifier, geographical zone, zone type, GPS coordinates, etc, can preferentially reflect the architecture of the database used so that these data can be extracted and used in calculations by one of the steps of the method of the invention.

According to one example, a project P₁ comprises a geographical zone Z₁, for example: “MALI”. According to one embodiment, a project P₁ can be associated with a program by a user U₁. The user U₁ can thus create a project P₁ named “Tsunami Relief” which can be concerned with the event, for example: “Victims of a natural disaster, such as the “Tsunami of Dec. 26, 2004 in the Indian Ocean”. Thus, the programs are accessible from an interface and can be classified in the form of categories.

According to another example, a project P₁ can be associated or attached to an entity. The definition of the project P₁ can therefore include the name of an entity. This name can be, for example, selected from a pre-existing list or possibly entered manually in a field of the interface by the user U₁. The entity can be an organization, a legal person such as a foundation, an association or an international organization, a company, etc. For example, the project P₁ can correspond to the entity “Doctors without Borders” or “Restaurants du Cceur”.

According to another example, one or more Pi projects can be associated with a cause. A cause corresponds to a category gathering a family of programs. An example might be all programs associated with responses to reduce global inequality or responses to protect the oceans. Subcategories of categories can also be defined. For example, the category “Ocean Protection” may include a subcategory: “Plastic Waste Treatment” or “Coral Protection”.

According to one example, programs can be accessed randomly for a set of entities. A random selection is made from a set of current programs. A command on an interface of an electronic equipment such as a PC or tablet or smartphone allows a user to access a list of programs for which a user project, that is an identifier and at least one sum, can be associated. The random program generator can be run on a remote server and a list of results is output to the user terminal which can then select one of them.

According to one embodiment, a user U₁ associates a project P₁ with a given type TYPE₁. The type TYPE₁ may be, for example, a category of programs. Programs can be classified according to different categories or subcategories. A single program can for example belong to different categories. The types can be defined by keywords such as TAGs or concepts of a particular ontology.

The set of programs is, for example, presented in a list accessible through a menu. The platform allows especially to define a donation in a new project P₁ and to associate it with one or more programs. According to another example, a project P₁ can additionally be associated with a geographical zone Z₁. According to one embodiment, a project P₁ is only associated with a geographical zone Z₁ without being associated with a program. In the latter case, the project P₁ may be associated with a program at a later stage of the method of the invention, such as at the step GEN_NOTIF₁.

The geographical zones Z₁ may designate towns, countries, or any territory resulting from a geographical or administrative division. The zone can be defined by latitude and longitude coordinates or be indexed on any type of reference frame allowing a geographical zone to be defined.

According to one embodiment, the platform includes a search engine that generates a list of programs or referenced zones for which a program it likely to be created. According to different criteria defined by the user, a subset of programs or zones can be automatically proposed to the user U₁. This subset can be proposed in the form of a list. The list can be generated based on donations already made by a user U₁, a user profile U₁ indicating preferences and sensitivities, a budget, a date, an urgency indicator, a donation achievement indicator or an impact indicator.

The impact indicator can be calculated, for example, from a proportion of a donation to a total budget planned to accomplish a program or a budget to perform an event within the program or a budget to perform an action within an event.

The urgency indicator can be generated, for example, from a digital piece of data associated with a program. A program that is associated with an urgency indicator can thus be more visible on the platform than programs that do not have this urgency indicator. By “more visible”, it is meant that the program will be generated in different lists more frequently.

The achievement indicator can be generated, for example, from a choice made by the user U₁ regarding the use of a donation made. A user U₁ can decide, for example, to display programs that only propose concrete actions or predefined uses of donations. For example, as it is the case for wedding lists, a user U₁ can decide to indicate a concrete use of a donation associated with the sum of the donation. This indication allows him/her to transmit to an organization a wish for the use of his/her donation.

The method of the invention allows a list of programs to be generated based on a combination of the previously defined criteria.

According to one embodiment, the method integrates a payment and payment verification step. This step is optional.

In case such a step is implemented, after finalizing the definition of a donation project P₁, the sum S₁ is then transferred from a first account to a second account. This step is noted as TRANS in FIG. 1. The transfer is done in a known way by a bank transaction such as a bank transfer, a debit or a credit card payment. A bank server SERV₂ is preferably chosen separately from the server SERV₁.

According to one embodiment, the method of the invention comprises a step GEN_EMP aimed at generating a digital fingerprint EMP. This digital fingerprint EMP allows the creation of a code intended for the user U₁ to follow the state of the project P₁. This code can be a reference, an alphanumeric identifier or any other digital piece of data allowing to uniquely identify the data of its project P₁. The digital fingerprint EMP can be a 2D code such as a QRcode, Flashcode or any other symbol encoding digital data in one, two or three dimensions.

The digital fingerprint EMP can be generated from a first criterion allowing the user U₁ to be identified, a second criterion allowing the defined project P₁ to be identified and possibly a piece of data indicating that the transfer TRANS of the donation has actually been carried out.

The first criterion can be a user identifier, a name, a telephone number or any other personal data allowing an identification of the user U₁.

The second criterion can be a project identifier. The project identifier can also be a name of a geographical zone Z₁.

An interest of the digital fingerprint EMP is to allow access to information for tracking the state of the project P₁ on the platform. Furthermore, the digital footprint EMP allows management of notifications to a user U₁ to be organized at different stages of the project P₁.

The method of the invention includes various steps aimed at generating notifications from a given entity to a user U₁. Notification issuances are transmitted from an entity's terminal, such as a PC, tablet, smartphone or directly from a server to a user terminal. A calculator can automatically generate the notifications under certain conditions. The user terminal can be a PC, a tablet, a Smartphone or directly a server. The notifications are issued subsequently to the action of an operator of an entity or automatically when an event is detected.

The method of the invention includes a step of generating GEN_NOTIF₁ a notification NOTIF₁. The first notification NOTIF₁ includes a first processing indicator IND₁, referred to as an “allocation indicator”. The generation of the first notification NOTIF₁ is preferably issued automatically successively to the assignment of a second geographical zone Z₂ to the project P₁. Among the events likely to be configured to generate a first notification NOTIF₁ to a user's terminal, there are especially:
An association by an operator of the user project with a predefined program or a sub-program of a program already selected by the user;
A given date;
An event related to a banking transaction;
A modification of the user project in the user project database, such as a modification of the digital status associated with the project, an acknowledgement, etc.
A gathering of the user project within a set of user projects, so it is an assignment of a project to a set of projects already gathered, for example within a program;
A definition of a new zone to be associated with the project or a change of zone or a modification of a zone previously associated with the project by the user himself/herself.

According to one embodiment, these events can also be used to generate a second notification NOTIF₂.

The first indicator IND₁ includes a mention of a second geographical zone Z₂. This mention represents an association between the project P₁ defined by the user U₁ with said second zone Z₂. The second geographical zone Z₂ may correspond to GPS coordinates, a district of a town, a town, a country or any other indication delimiting a locatable geographical perimeter.

Advantageously, the first notification NOTIF₁ is time-stamped. To this end, the processing indicator IND₁ may include a date H₂ on which the allocation of all or part of the sum S₁ will be processed. According to one embodiment, the date H₂ is the date of issue of the notification NOTIF₁.

The processing indicator IND₁ includes a value representing the amount of a second sum S₁₁ less than or equal to the first sum S₁. When the second sum S₁₁ is equal to the first sum S₁, the entire amount S₁₁ is allocated to a program in a zone Z₂. The user U₁ is thus informed of this allocation and thus of the progress of the status of his/her project P₁.

When the amount S₁₁ is less than the sum S₁, the processing indicator IND₁ includes the value of the sum S₁₁. According to one exemplary embodiment, the notification NOTIF₁ may include a third sum S₁₂ that is less than the first sum S₁ and an indication of an allocation of this third sum S₁₂ to another program or to the same program at a later date.

According to one embodiment, a plurality of notifications NOTIF₁ are issued to a plurality of users Uᵢ, each notification NOTIF₁ including information specific to each user Uᵢ and the allocated sums S₁₁. One advantage is to allocate a global amount MG to a given program at a given date and to distribute fractions of sums to a plurality of users Uᵢ automatically.

Thus, at each allocation of a sum by an entity to a given program, the global amount MG allocated can be split according to a set of users who have each made a donation.

One advantage of the method of the invention is to define sets of users who have each made a donation and to associate their contribution to a given program. It is recalled that one purpose of the invention is to notify a user of the state of tracking of his/her donations. However, a drawback for an entity resulting from the generation of tracking notifications is to multiply particular treatments, especially for each user. An interest of the invention is therefore to simplify management of a plurality of individual tasks. Indeed, the method of the invention allows the preferences defined by the users {Ui}_{iε[1,N]} to be used when defining donation projects, such as the geographical zone, program category, amount of donations, date of donation transfers, etc. This usage allows for the mutualization of processing operations related to notifications.

Indeed, these preferences allow to create sets of users that will be associated to each allocation to the same program. One interest is to mutualize processing of the notifications NOTIF₁.

The method of the invention makes it possible to associate a donation from a user U₁ with several programs which may represent subprograms of the same program. By way of example, if a program is the electrification of a village, different sub-programs can represent different stages over a given period of this program.

According to one example, the amount of a donation S₁ is compared to a minimum amount threshold MS. When the value of the donation is less than MS, the sum of the donation S₁ is not fragmented. In this case, a single notification NOTIF₁ is issued.

When the sum S₁ is greater than a minimum threshold MS and another condition is met, then the method of the invention enables the sum S₁ to be fragmented.

The condition can be related to different cases:
an amount S₁ greater than a sum threshold MM_{AX};
a number of users Uᵢ greater than a given threshold having made a donation that is allocated to the same program;
a number of sub-programs of the same program including different dates,
an indicator of a user wishing to distribute his/her donation amount among different programs.

It can also be a combination of these different conditions. For this purpose, an algorithm can be implemented to associate weights to the different conditions.

The dotted arrows S₁₂ and S₁₃ illustrate several scenarios for splitting an initial sum S₁. As an example, a program may relate to different regions, such as a tsunami that affected several regions. Given the distribution of aid over time, a possible distribution scenario is an allocation at a date H₂ of a first sum S₁₁ to a first zone Z₂ and a subsequent allocation at a date H₂₁ of a sum S₁₂ to a zone Z₂₁ and so on with S₁₃ until the total amount S₁ is exhausted.

One interest is to deliver notifications at each new allocation of a sum to a given geographical zone.

The method of the invention allows a second notification NOTIF₂ to be generated to each user U₁. The second notification NOTIF₂ aims at transmitting to a user U₁ an information relating to the distribution of the sum S₁ or S₂₁, hereinafter referred to as S₁. It corresponds to an actual use of the sum S₁. The second notification NOTIF₂ further includes a third date H3 which corresponds to a usage of the sum in a geographical zone. The notification NOTIF₂ includes the indication of a third zone Z₃. According to one example, the third zone Z₃ is identical to the second zone Z₂. This may occur when the allocation of a sum intended for a given location is actually allocated to that zone when used. According to one example, it may be a transfer of all or part of the sum from the second bank account to a third bank account. In this case, the second notification NOTIF₂ can be issued automatically to the first terminal T₁. When a third geographical zone Z₃ has been associated with the project P₁ or with the part of the amount transferred, the second notification NOTIF₂ includes a piece of data characterizing the third geographical zone Z₃.

However, it may happen that the sum S₁ is used in a zone Z₃ included in the second zone Z₂. This case may occur often since a program that targets, for example, one country may include different local actions, for example in different towns. For example, if Z₂ targets a country such as MALI, Z₃ may designate a town such as TOMBOUCTOU. In this case, one advantage of defining a third zone Z₃ is that it allows more precise information to be delivered to a user about the usage of his/her donations. Such feedback allows him/her to be more aware of the usage of the donations he/she has made.

According to one example, Z₃ can relate to another region than Z₂, or even a disjoint region. This can happen when there is a change in the distribution of the sums. For example, this may occur when an urgency program has occurred. In this case, a prioritization indicator may pre-empt some allocations that have already been made and notified. This reallocation of a sum can also occur when the user has not specified a zone Z₁ when defining his/her project P₁. Thus, no zone restriction prevents a reallocation of the sum S₁ to a location other than the one notified in the notification NOTIF₁.

The distribution indicator IND₂ included in the second notification NOTIF₂ may include, for example, information specifying:
the date of transfer of the sum to a local entity located in zone Z₃;
equipment received by a local entity located in the zone Z₃;
the completion of an action performed by a local entity in the zone Z₃;
the end date of an event organized by a local entity in the zone Z₃,
A given quantity corresponding to the sum S₁, S₁₁ or S₂₁ paid.

This information may correspond to a processing state ET₁ of the sum S₁ or S₁₁ or S₂₁.

According to one exemplary embodiment, the given quantity may correspond to a quantity of processed waste. In this example, an event corresponds, for example, to the waste collection on the surface of the sea during a period of 3 months. In this case, at the end of the event, a quantity of waste is collected or treated. An estimate of the volume or weight is usually made to quantify the benefit of an operation. The method of the invention makes it possible to split up this estimate to evaluate the unit cost. Thus, it is possible to associate a sum, and thus the value of a donation, with a fraction of the estimate. One advantage is that it allows a user to obtain a quantitative return on his/her contribution in addition to a qualitative appreciation of his/her contribution to a program. Increased awareness can be obtained from a community of users. This awareness allows for an increase in the sums donated and allows for better promotion of certain events that are part of certain causes defended by entities.

According to one example, the state ET₁ can include a status: “in progress”, “completed”, “to come”. An interest is to deliver information on tracking the actions carried out with the sum S₁ transferred by the user Uᵢ.

Other NOTIF₂ type notifications can be issued to a terminal of the user Uᵢ to inform, if necessary, of a change of state of the sum S₁ and possibly of a change of status of this state ET₁.

According to one embodiment, the second notification NOTIF₂ specifies an amount S₂₁ less than the amount S₁ or S₁₁. This may occur when a portion of the sum S₁ or S₁₁ is converted locally in a state ET₁. One advantage is to inform a user U₁ about the real use of his/her donations. An allocated sum can indeed be distributed within different purchases or actions that correspond to particular phases of a program. In this case, a plurality of notifications NOTIF₂ can be generated to a user.

The method of the invention may comprise a third step of issuing a third notification NOTIF₃. However, according to one embodiment, the data of the notification NOTIF₃ may be included in the second notification NOTIF₂ previously described. This may occur when the data of the notification NOTIF₃ are already available or when it is deliberately chosen to gather these two notifications in some implementations of the method of the invention.

According to one embodiment, the third notification NOTIF₃ comprises a media M₁. The media may be at least one image, at least one video or at least one sound file. The media is intended to present a use of the donation or a testimonial or any other image presenting, for example, a facility made with the sum transferred by the user Uᵢ.

The media M₁ is preferably time-stamped with a date H₄. Time stamping allows information to be delivered in accordance with the time when the media was performed or when it was issued. Time stamping can be, for example, automatically extracted from a digital device likely to produce the media. For this purpose, a processing of the media's metadata can be exploited to automatically generate a date H₄. The media can be geolocated by means of a smartphone or a digital tablet with a geolocation method, for example.

FIG. 1, illustrates the steps of a method possibly including different branches of processing a sum S₁ divided into two sub-sums S₁₁ and S₁₂. It is understood in this representation that the same steps of generating notifications GEN_NOTIF₁₁ and GEN_NOTIF₂₁ and GEN_NOTIF₃₁ can be performed with data specific to each phase of a program or several programs.

Thus, such a method allows a user to know a real usage of one or more donations through different programs. One advantage is to offer a real donation tracking tool, for example, for an entity, a foundation or a person in particular. This donation tracking principle allows a user to effectively communicate on the use of his/her donations. Furthermore, such a method increases the trust a user may have in an entity to administer and distribute his/her donations. In addition, this tracking can generate performance or quality indicators on the exploitation of the donation processing.

Especially, an indicator related to the average time for processing a donation by an entity can be generated. Another indicator relating to the exploitation of the sums can be generated.

According to different embodiments, the method generates punctual or regular statistics that allow qualification of data of donors, organizations that can be organized by project, by period or by program.

The statistics make it possible to cross-reference information on donations, transactions, projects, users and donors who have generated the most transactions, donations and over which periods or geographical zones.

FIG. 2 illustrates the computing means that can be used to execute the method of the invention.

For this purpose, a plurality of terminals T₁, T₂, T₃ are represented. In this example, T₁ illustrates a user-donor terminal. T₂ illustrates a terminal of an operator of an entity from which an allocation of a sum S₁ is performed. According to this example, the distribution indicator IND₂ present in the notification NOTIF₂ may also be generated from this same terminal T₂. T₃ illustrates a local terminal from which the media M₁ is performed.

Servers SERV₁ and SERV₂ represent two servers. A first server SERV₁ can, for example, host the platform and centralize exchanges to generate the notifications to the users Uᵢ. A first individual uses a terminal T₁ in order to connect to a platform centralizing data related to the different programs.

The server SERV₂ can be a bank server allowing the transfer of donations from a first account of a user to a second account of an entity.

The invention thus allows for improved transmission of data between entities, for example between a donor and an organization. A donor can be any natural or legal person and an organization is preferably a legal person, such as a company, an association, a foundation, or an NGO. One advantage is to facilitate accessibility of information on the entire donation process.

1. A method for automatically generating notifications for tracking a sum between a user, called a first donor and a receiving entity, the method comprising:
defining a project including a selection of a first sum and a receiving entity from a user interface of a user terminal;
transferring said first sum from a first account associated with the first donor to a second account associated with the receiving entity;
generating a digital fingerprint associating at least one identifier of the first donor with one identifier of the project;
automatically generating by a calculator to the first donor a first notification including a first processing indicator, called an allocation indicator, indicating an association of the project identifier with a second geographical zone, a second date and an amount of a second sum less than or equal to the first sum;
automatically generating by a calculator to the first donor a second notification including a second processing indicator, called a distribution indicator, said distribution indicator indicating an association of the project identifier with a third geographical zone, a third date and a state.

2. The method according to claim 1, wherein defining a project comprises selecting a first geographical zone.

3. The method according to claim 1, wherein a set of programs is predefined, each program defining a set of actions to be performed in a predefined zone on at least one given date.

4. The method according to claim 3, wherein each program includes a first type for defining program categories.

5. The method according to claim 3, wherein defining a project comprises selecting a first type.

6. The method according to claim 3, wherein defining a project comprises defining:
an impact indicator calculated on a proportion of a user's donation relative to a reference,
an urgency indicator calculated from a date of an event of a program,
an achievement indicator defined from a predefined value of an attribute of the event mentioning the result of an action.

7. The method according to claim 1, wherein the first notification is issued as a result of a modification of a piece of data characterizing the project within a database of a remote server gathering a set of projects, said piece of data being a digital status of the project or a piece of data relating to a new association of a project with a geographical zone or a piece of data relating to gathering of user projects in a same set of projects.

8. The method according to claim 1, wherein the second notification is issued as a result of the initiation of a transfer of a sum from the second account to a third account of an entity, the third account being attached to a reference geographical zone.

9. The method according to claim 1, further comprising generating a third notification including a third processing indicator, called a media indicator, said media indicator being associated with a media including at least one image.

10. The method according to claim 1, wherein the generation of a fourth notification including a second allocation indicator, said second allocation indicator indicating an association of the project identifier with a fourth geographical zone, with a second date and with an amount of a third sum less than or equal to the first sum.

11. The method according to claim 3, wherein the first sum is divided into a plurality of sums depending on conditions among which:
the amount of the first sum is greater than a sum threshold;
a number of users is greater than a given threshold of users, said users having made a donation allocated to a same program;
a number of sub-programs of the same program included different dates,
an indicator of a user wishing to distribute his/her donation amount among different programs.

12. A system including at least one user terminal, a terminal of an operator of an entity, communication means of said terminals, at least one server for generating notifications following at least one action performed by said operator on the second terminal, a second server for enabling a banking transaction from a first account to a second account, said terminals and the first server being configured to implement the method of claim 1.

13. A system including at least one user terminal, a terminal of an operator of an entity, communication means for connecting said terminals to a data network, at least one first server for generating notifications following at least one action performed by said operator on the second terminal, a second server for enabling a banking transaction from a first user account to a second account of an entity, the first terminal including an interface to define a project including an identifier, a first geographical zone and at least one sum, said data being transferred through a data network to at least the first remote server, the interface further enabling said banking transaction to transfer said sum, the second terminal including a communication interface for retrieving the data transmitted by the first terminal, and a user interface for associating a second geographical zone with said project, said data being recorded in a memory of the first server to be then automatically issued via a first notification through the data network to the first terminal said first notification including at least one piece of data relating to the project and a piece of data describing the second geographical zone and a date piece of data, a second notification being automatically sent to the first terminal as a result of processing of part of the sum of the second bank account, said third notification including a piece of data characterizing a third geographical zone.
